(19) United States
(12) Patent Application Publication
(10) Pub. No.: US 2025/0198778 A1
(43) Pub. Date: Jun. 19, 2025

(54) INFORMATION PROCESSING DEVICE AND INFORMATION PROCESSING METHOD

(71) Applicant: TOYOTA JIDOSHA KABUSHIKI KAISHA, Toyota-shi (JP)

(72) Inventor: Makoto MATSUSHITA, Ichinomiya-shi (JP)

(73) Assignee: TOYOTA JIDOSHA KABUSHIKI KAISHA, Toyata-shi (JP)

(21) Appl. No.: 18/894,625

(22) Filed: Sep. 24, 2024

(30) Foreign Application Priority Data
Dec. 19, 2023 (JP) 2023-214087

(51) Int. Cl. G01C 21/34; G07C 5/02

(52) U.S. Cl. CPC G01C 21/3469; G07C 5/02

(57) ABSTRACT

An information processing device includes a control unit that presents, on a display screen of the navigation device, a first route including a section capable of green wave traveling, which is created in response to a request from the navigation device of the vehicle, and presents a predetermined traveling speed on the display screen when the vehicle enters a starting point of the section.

### CROSS-REFERENCE TO RELATED APPLICATION

This application claims priority to Japanese Patent Application No. 2023-214087 filed on Dec. 19, 2023, incorporated herein by reference in its entirety.

### BACKGROUND

### 1. Technical Field

The present disclosure relates to an information processing device and an information processing method.

### 2. Description of Related Art

Hitherto, technologies for controlling travel of vehicles have been known. For example, Japanese Unexamined Patent Application Publication No. 2014-184776 (JP 2014-184776 A) discloses a technology of switching electric travel and hybrid travel depending on a stored charge level of a battery.

### SUMMARY

When a vehicle 10 is forced to stop at red signals and frequently accelerates and decelerates unnecessarily to repeat stop and go, the stored charge level of the battery decreases more quickly. JP 2014-184776 A focuses on the switching of the power source depending on the stored charge level of the battery during the travel, but no consideration is made about suppression of the decrease in the stored charge level of the battery by traffic signal control between traffic signal intersections. Therefore, there is room for improvement in the technology for controlling the travel of the vehicle.

In view of these circumstances, an object of the present disclosure is to improve a technology for controlling the travel of a vehicle.

An information processing device according to one embodiment of the present disclosure includes:
a communication unit; and
a control unit configured to perform communication using the communication unit.
The control unit is configured to present, on a display screen of a navigation device of a vehicle, a first route including a section where green wave travel is possible and created in response to a request from the navigation device, and present a predetermined travel speed on the display screen when the vehicle enters a start point of the section.

An information processing method according to one embodiment of the present disclosure includes
causing an information processing device to:
create a first route including a section where green wave travel is possible in response to a request from a navigation device of a vehicle;
present the created first route on a display screen of the navigation device; and
present a predetermined travel speed on the display screen when the vehicle enters a start point of the section.

According to the embodiments of the present disclosure, the technology for controlling the travel of the vehicle is improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a schematic configuration example of a system according to an embodiment of the present disclosure;

FIG. 2 is a flowchart illustrating an operation example of the information processing device;

FIG. 3 is a schematic diagram illustrating green wave travel; and

FIG. 4 is a schematic diagram illustrating a section in which green wave traveling is possible.

### DETAILED DESCRIPTION OF EMBODIMENTS

Hereinafter, an embodiment of the present disclosure will be described.

### Outline of Embodiment

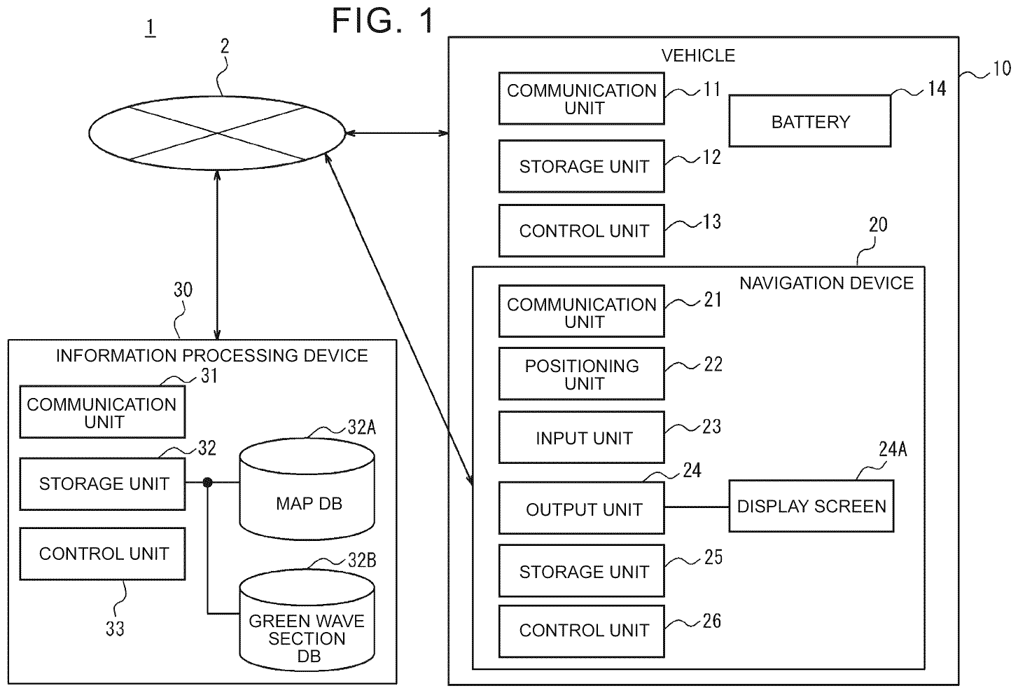

The outline of a system 1 according to an embodiment of the present disclosure will be described with reference to FIG. 1. The system 1 includes a vehicle 10, a navigation device 20, and an information processing device 30. The navigation device 20 is mounted on the vehicle 10. The vehicle 10, the navigation device 20, and the information processing device 30 are communicably connected to a network 2 including, for example, the Internet and a mobile communication network.

The vehicle 10 is, for example, an automobile, but is not limited to this, and may be any vehicle. The automobile can be a gasoline-powered vehicle, a battery electric vehicle (BEV), a hybrid electric vehicle (HEV), a plug-in hybrid electric vehicle (PHEV), or a fuel cell electric vehicle (FCEV). However, automobiles are not limited thereto. In the present disclosure, the vehicle 10 will be described as being a BEV. However, the vehicle 10 is not limited to a BEV, and may be an HEV or a PHEV, or a gasoline-powered vehicle.

The vehicle 10 is wirelessly connected to the navigation device 20 and the information processing device 30 via the network 2 so as to be able to communicate with each other. Further, the vehicles 10 may be communicably connected to the communication unit 21 of the navigation device 20 via the communication unit 11 via a wired connection such as a CAN. The number of vehicles 10 included in the system 1 may be arbitrarily determined.

The navigation device 20 is a car navigation device installed in the vehicle 10. However, the navigation device 20 is not limited to the so-called “car navigation” installed in the dashboard of the vehicle 10. The navigation device 20 may be a so-called “smart phone navigation” in which a smart phone or a tablet terminal carried by a driver of the vehicle 10 is temporarily installed on a dashboard and a car navigation application is executed on a display screen 24A of the terminal. The navigation device 20 is wirelessly connected to the vehicle 10 and the information processing device 30 via the network 2 so as to be able to communicate with each other. In addition, the navigation device 20 may be communicably connected to the communication unit 11 of the vehicle 10 via the communication unit 21 via a wired connection such as a CAN.

The information processing device 30 is, for example, a computer such as a navigation server. The information processing device 30 is wirelessly connected to the vehicle 10 and the navigation device 20 via the network 2 so as to be able to communicate with each other.

First, the outline of the present embodiment will be described, and the details will be described later. The information processing device 30 presents, on the display screen 24A of the navigation device 20, a first route including a section capable of green wave traveling, which is created in response to a request from the navigation device 20 of the vehicle 10. The information processing device 30 presents a predetermined traveling velocity on the display screen 24A when the vehicles 10 enter the starting point of the section.

As described above, according to the present embodiment, the information processing device 30 presents a section in which the green wave travels on the display screen 24A of the navigation device 20 and a predetermined traveling velocity in the section. Therefore, for example, even in a case where the navigation device 20 does not possess information on a section in which green wave travel is possible, the vehicle 10 can perform green wave travel with the support of the information processing device 30. Therefore, the technique of controlling the traveling of the vehicle is improved in that the probability that the amount of electric power consumed by the vehicle 10 during traveling can be reduced is improved.

Next, each configuration of the system 1 will be described in detail.

### Configuration of Vehicle

As illustrated in FIG. 1, the vehicle 10 includes a communication unit 11, a storage unit 12, a control unit 13, a battery 14, and a navigation device 20. Details of the navigation device 20 will be described later.

The communication unit 11 includes one or more communication interfaces that are wired to the communication unit 21 of the navigation device 20. The communication interface corresponds to, for example, a communication standard of an in-vehicle network such as a CAN or a wired local area network (LAN), but is not limited thereto, and may correspond to any communication standard. Further, the communication unit 11 includes one or more communication interfaces wirelessly connected to the network 2. The communication interface conforms to a mobile communication standard, such as 4th generation (4G) or 5th generation (5G), but is not limited thereto.

The storage unit 12 includes one or more memories. The memories are, for example, a semiconductor memory, a magnetic memory, or an optical memory, but are not limited to these memories. Each memory included in the storage unit 12 may function as, for example, a main storage device, an auxiliary storage device, or a cache memory. The storage unit 12 stores any information that is used for operation of the vehicle 10. For example, the storage unit 12 may store a system program, an application program, and embedded software.

The control unit 13 may include one or more processors, one or more programmable circuits, one or more dedicated circuits, or a combination thereof. The processors are, for example, a general-purpose processor such as a central processing unit (CPU) or a graphics processing unit (GPU), or a dedicated processor specialized for a specific process, but are not limited to these processors. The programmable circuits are, for example, a field-programmable gate array (FPGA), but are not limited to the circuit. The dedicated circuits are, for example, an application specific integrated circuit (ASIC), but are not limited to the circuit. The control unit 13 controls the overall operation of the vehicle 10.

The battery 14 is a rechargeable secondary battery mounted on a BEV, an HEV or a PHEV and capable of being repeatedly charged. The type of the secondary battery is, but not limited to, a lithium-ion battery, a lead-acid battery, a nickel-metal hydride battery, a nickel-cadmium battery, an all-solid-state battery, or the like. The battery 14 also supplies power to the communication unit 11, the storage unit 12, the control unit 13, and the navigation device 20 of the vehicle 10.

### Configuration of the Navigation Device

As illustrated in FIG. 1, the navigation device 20 includes a communication unit 21, a positioning unit 22, an input unit 23, an output unit 24, a storage unit 25, and a control unit 26.

The communication unit 21 includes one or more communication interfaces wired to the communication unit 11 of the vehicle 10. The communication interface corresponds to, for example, a communication standard of an in-vehicle network such as a CAN or a wired LAN standard, but is not limited thereto, and may correspond to any communication standard. Further, the communication unit 11 includes one or more communication interfaces wirelessly connected to the network 2. The communication interfaces correspond to mobile communication standards such as 4G or 5G, but are not limited thereto.

The positioning unit 22 includes one or more devices that acquire position information of the vehicle 10. Specifically, the positioning unit 22 includes, for example, a receiver corresponding to GPS, but is not limited thereto, and may include a receiver corresponding to any satellite-based positioning system.

The input unit 23 includes at least one input interface capable of accepting an input by a driver of the vehicle 10. The input-interface is, for example, a physical key, a capacitive key, a pointing device, a camera, a touch screen integrally provided with a display screen 24A of an output unit 24 to be described later, a microphone that picks up a sound of a driver, or the like. However, the input interface is not limited thereto.

The output unit 24 is configured to include at least one audio output interface capable of outputting audio and at least one display interface capable of displaying text or video. The audio output interface is, for example, a speaker. The display interface is, for example, a display screen such as an LCD or an organic EL display (referred to as a display screen 24A in the present disclosure). The audio output interface and the display interface are not limited thereto.

The storage unit 25 includes one or more memories. The memories are, for example, a semiconductor memory, a magnetic memory, or an optical memory, but are not limited to these memories. For example, each memory included in the storage unit 25 may function as a main storage device, an auxiliary storage device or a cache memory. The storage unit 25 stores arbitrary information used for the operation of the navigation device 20. For example, the storage unit 15 may store a system program, an application program, embedded software, map information, and the like. The information stored in the storage unit 25 may be updatable by, for example, information acquired from the network 2 via the communication unit 21.

The control unit 26 includes one or more processors, one or more programmable circuits, one or more dedicated circuits, or a combination thereof. The control unit 26 controls the overall operation of the navigation device 20.

### Configuration of Information Processing Device

As illustrated in FIG. 1, the information processing device 30 includes a communication unit 31, a storage unit 32, and a control unit 33.

The communication unit 31 includes one or more communication interfaces connected to the network 2. The communication interface conforms to, for example, a mobile communication standard, a wired LAN standard, or a wireless LAN standard. However, the standards are not limited to these, and the communication interface may conform to any communication standard. In the present embodiment, the information processing device 30 communicates with the vehicle 10 and the navigation device 20 via the communication unit 31 and the network 2.

The storage unit 32 includes one or more memories. Each memory included in the storage unit 32 may function as, for example, a main storage device, an auxiliary storage device, or a cache memory. The storage unit 32 stores arbitrary information used for the operation of the information processing device 30. For example, the storage unit 32 stores a system program, an application program, and the like. Further, the storage unit 32 includes a map database 32A for storing a map of a region in which the vehicle 10 travels, and a green wave section database 32B for storing a power cost of a section in which the vehicle 10 travels in a green wave. The information stored in the storage unit 32 may be updatable by, for example, information acquired from the network 2 via the communication unit 31.

The control unit 33 includes one or more processors, one or more programmable circuits, one or more dedicated circuits, or a combination thereof. The control unit 33 controls the overall operation of the information processing device 30.

### Operation Flow of Information Processing Device

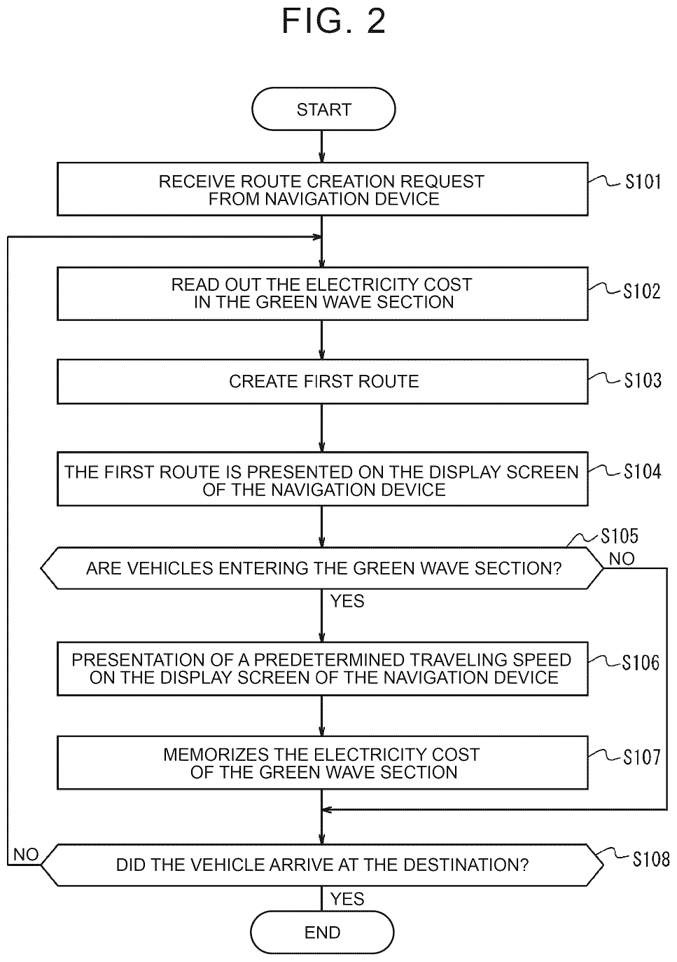

An operation of the information processing device 30 according to the present embodiment will be described with reference to FIG. 2. The present operation relates to the presentation of a route including a section capable of green wave traveling.

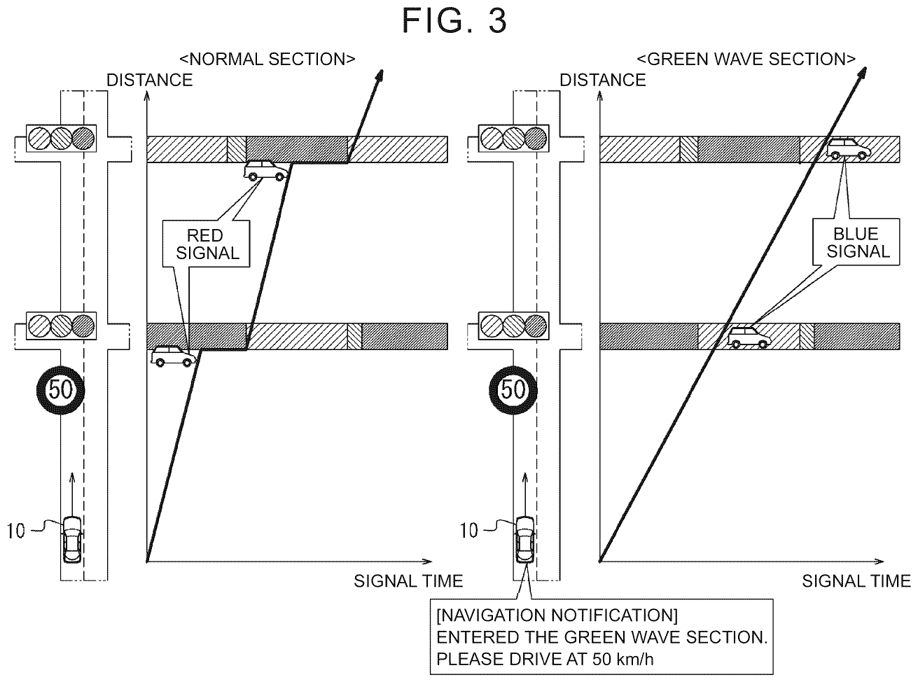

FIG. 3 is a schematic diagram illustrating green wave running. Green Wave refers to a technique for reducing the average number of stoppages of a vehicle by controlling the speed of the entire vehicle so that all vehicles traveling between intersections where traffic lights are installed can pass with a blue signal. As shown in FIG. 3, in the normal section, when the vehicle 10 travels at any velocity, the vehicle may be forced to stop with a red signal, and unnecessary acceleration/deceleration in which Stop/Go is repeated increases, so that SoC of the battery 14 decreases quickly. On the other hand, as long as the vehicle 10 travels at a legal speed, the vehicle travels in a section where the green wave travels, which can pass between the signal intersections with a blue signal. As a result, a state of charge (SoC) of the battery 14 can be suppressed from decreasing and SoC can be efficiently traveled.

SoC is an index indicating a charge rate (or a state of charge) of the battery. SoC is defined as 100% when the battery is fully charged and 0% when it is fully discharged. For example, when a battery with a full charge capacity of 2000 mAh is discharged 500 mAh from full charge, SoC of the battery is (2000−500)/2000×100=75%.

S101: The control unit 33 receives a route creation request from the navigation device 20 of the vehicle 10.

The navigation device 20 (referred to as “navigation device” in FIG. 2) requests the information processing device 30 (navigation server) to create a route including the green wave section Sg that is SoC efficient when it does not have information about the section Sg (hereinafter referred to as “green wave section Sg”) capable of performing green wave travel.

S102: The control unit 33 reads the electricity cost of the green wave section Sg stored in the storage unit 32.

In S107 described later, the electric power cost from the start point to the end point of the green wave section Sg that the vehicles 10 have traveled in the past is stored in the green wave section database 32B (green wave section DB) of the storage unit 32. The control unit 33 reads the electricity cost of the green wave section Sg from the green wave section database 32B.

In BEV, the term “fuel consumption” of gasoline-powered vehicles is “electricity consumption”. The electric power cost is an index indicating the electric power required for 1 km to travel, and is expressed in units of “kWh/km”. The electric power cost is calculated by the following Expression (1).

$$Electricity cost ( kWh / km ) = battery capacity ( kWh ) / distance ( km ) \qquad ( 1 )$$

Note that the electric power cost may be expressed in units of “km/kWh”. In such a notation, the electricity cost indicates the mileage per kilowatt hour (kWh) of electric energy.

S103: The control unit 33 creates a first route R1 including the green wave section Sg.

Based on the following (i) to (iii), the control unit 33 creates the first route R1 in which the remaining charge level when the vehicles 10 arrive at the destination is the largest.
(i) Electricity cost (kWh/km) obtained by dividing the electric energy consumed by the vehicles 10 while traveling from the start point to the end point of the green wave section Sg by the distance of the green wave section Sg. The electric energy consumed by the vehicles 10 while traveling from the starting point to the end point of the green wave section Sg is stored in the green wave section database 32B of the storage unit 32.
(ii) The remaining charge of the battery 14 at the departure point of the vehicle 10 (battery capacity (kWh)× SoC (%)).
(iii) The distance of the plurality of routes connecting the departure point and the destination of the vehicle 10, including the green wave section Sg.

Note that the control unit 33 may use a numerical value (nominal value) announced by a manufacturer of the vehicle 10 for the electric power cost of a section other than the green wave section Sg in the first route R1. The battery capacity of BEV is expressed in “kWh (kilowatt hour)”. “kWh” indicates the amount of electric power that can be extracted per hour, and the higher the value of “kWh”, the higher the performance as a battery.

For example, the electric power cost of the green wave section Sg is Eg, the electric power cost announced by the manufacturer is En, the battery capacity of the vehicle 10 is Bc, the distance of the first route R1 is DI, and the distance of the green wave section Sg is Dg. At this time, the remaining charge Br when the vehicle 10 arrives at the destination through the first route R1 is calculated by the following Expression (2) as an example. However, the calculation method is not limited thereto.

$$Br = Bc * SoC - ( Eg * Dg + En * ( D 1 - Dg ) ) \qquad ( 2 )$$

For example, it is assumed that the power cost Eg of the green wave section Sg is 100 Wh/km, the battery capacity Bc is 70 kWh, SoC at the departure point of the vehicle 10 is 90%, and En of power costs announced by the manufacturer of the vehicle 10 is 125 Wh/km. Further, the distance DI of the first route R1 connecting the departure point and the destination of the vehicles 10 is 50 km, and the distance Dg of the green wave section Sg is 30 km. At this time, the remaining charge Br when the vehicles 10 arrive at the destination is calculated as

Br=70*0.9−(0.1*30+0.125*20)=63−(3+2.5)=57.5(kWh).

SoC of the battery 14 when the vehicle 10 arrives at the destination is 57.5/70×100=82%.

S104: The control unit 33 presents the first route R1 including the created green wave section Sg on the display screen 24A of the navigation device 20.

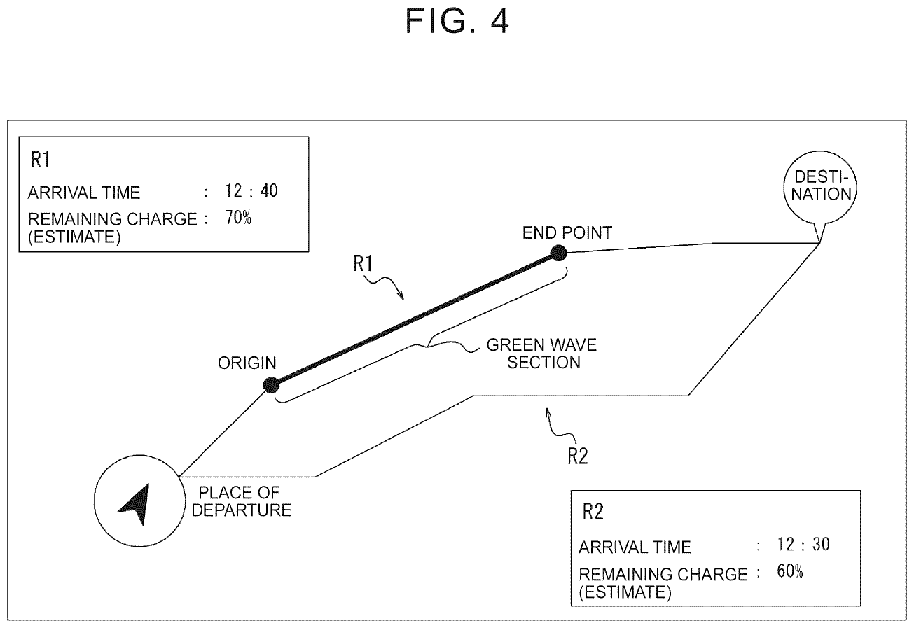

FIG. 4 is a schematic diagram illustrating a green wave section Sg. As illustrated in FIG. 4, the control unit 33 may further present the second route R2 not including the green wave section Sg on the display screen 24A. The control unit 33 may present, for the first route R1 and the second route R2 presented on the display screen 24A, an estimated time at which the vehicle arrives at the destination and an estimated remaining charge of the battery 14 at the estimated time. The “remaining charge amount (estimated): 70%” displayed in FIG. 4 indicates that the estimated value of the remaining charge amount of the battery 14 at the scheduled time when the vehicle 10 arrives at the destination is 70% of the battery capacity. Although only two paths of the first route R1 and the second route R2 are shown in FIG. 4, the numbers of the presented paths may be arbitrarily determined.

As illustrated in FIG. 4, the control unit 33 presents the first route R1 and the second route R2 connecting the departure point and the destination on the display screen 24A. The first route R1 includes a green wave section Sg. The driver of the vehicle 10 can select either the first route R1 or the second route R2 on the display screen 24A. When any route is selected, the control unit 26 of the navigation device 20 starts route guidance to the destination via the route selected from the departure point. In the embodiment of FIG. 4, when the first route R1 is selected in selecting the first route R1 or the second route R2, the arrival time to the destination is delayed by 10 minutes. However, a difference in the remaining charge amount to the destination is presented, such that the estimated value of the remaining charge amount at the arrival time is 10% higher. According to such a configuration, the traveling of the green wave section Sg is encouraged, and the energy-consumption is reduced.

S105: The control unit 33 determines whether or not the vehicles 10 have entered the starting point of the green wave section Sg. If the vehicle 10 enters the starting point of the green wave section Sg, it advances to S106, if not, it advances to S108.

S106: The control unit 33 presents a predetermined travel speed on the display screen 24A.

The predetermined traveling speed is a legal speed such as 50 km/h shown in FIG. 3. As shown in FIG. 3, when the vehicles 10 enter the starting point of the green wave section Sg, the control unit 33 presents a notification on the display screen 24A, for example, “You have entered the green wave section, please drive at 50 km/h.”

The control unit 26 of the navigation device 20 may control the cruise control device to cause the vehicle 10 to travel at a predetermined travel speed when a predetermined travel speed is received from the control unit 33.

In addition, even when the navigation device 20 is not performing route guidance, the control unit 33 may present a predetermined traveling velocity on the display screen 24A when the vehicle 10 enters the starting point of the green wave section. According to such a configuration, since the lowering of SoC of the battery 14 is suppressed by changing the traveling speed of the vehicles 10 to the predetermined speed, SoC efficient traveling is enabled.

S107: The control unit 33 stores, in the storage unit 32, the electricity cost obtained by dividing the electric energy consumed during traveling from the start point to the end point of the green wave section Sg, which is received from the vehicle 10, by the distance of the green wave section Sg.

The control unit 33 receives the electric power consumed during the traveling from the vehicles 10 traveling from the starting point to the end point of the green wave section Sg. The control unit 33 stores, in the green wave section database 32B (green wave section DB) of the storage unit 32, the electricity cost obtained by dividing the amount of electric power consumed during traveling by the distance of the green wave section Sg. Note that the control unit 33 may receive the actual power cost of the green wave section Sg from the vehicles 10.

S108: The control unit 33 determines whether or not the vehicle 10 has arrived at the destination. When the vehicle 10 has not arrived at the destination, S102 returns to continue the information processing, and when the vehicle has arrived at the destination, the information processing is ended.

When the vehicle 10 has not arrived at the destination, the control unit 33 may return to S102 and create the first route R1 again.

As described above, the information processing device 30 according to the present embodiment presents the first route R1 including the green wave section Sg, which is created in response to a request from the navigation device 20 of the vehicle 10, on the display screen 24A of the navigation device 20. Then, the information processing device 30 presents a predetermined traveling velocity on the display screen 24A when the vehicles 10 enter the starting point of the green wave section Sg.

According to this configuration, the information processing device 30 presents the green wave section Sg and the predetermined traveling velocity in the green wave section Sg on the display screen 24A of the navigation device 20 in the information processing device 30. Therefore, for example, even when the navigation device 20 does not possess the information on the green wave section Sg, the vehicles 10 can run on the green wave with the support of the information processing device 30. Therefore, the technique of controlling the traveling of the vehicle is improved in that the probability that the amount of electric power consumed by the vehicle 10 during traveling can be reduced is improved.

Although the present disclosure has been described above based on the drawings and the embodiment, it should be noted that those skilled in the art may make various modifications and alterations thereto based on the present disclosure. It should be noted, therefore, that these modifications and alterations are within the scope of the present disclosure. For example, the functions included in the configurations, steps, etc. can be rearranged so as not to be logically inconsistent, and a plurality of configurations, steps, etc. can be combined into one or divided.

For example, in the above-described embodiment, the configuration and operation of the information processing device 30 may be distributed among a plurality of computers capable of communicating with each other. Further, for example, an embodiment in which some or all of the components of the information processing device 30 are provided in the navigation device 20 mounted on the vehicle 10 is also possible. For example, the navigation device 20 receives the information on the green wave section Sg and the statutory velocity from the navigation server (the information processing device 30) or the roadside device. At this time, the navigation device 20 may be configured to initiate route guidance including the green wave section Sg.

In the above-described embodiment, the vehicle 10 is described as being a BEV, but the vehicle 10 may be a gasoline-powered vehicle or an HEV or PHEV while the vehicle is running. When the vehicle 10 that performs the engine running selects a route including the green wave section Sg, the fuel efficiency of the green wave section Sg is improved, and the consumption of gasoline (or diesel oil, LNG, etc.) is reduced, so that the energy consumption is expected to be suppressed.

Further, for example, an embodiment in which a general-purpose computer functions as the information processing device 30 according to the above-described embodiment is also possible. Specifically, a program describing processing contents for realizing each function of the information processing device 30 according to the above-described embodiment is stored in a memory of a general-purpose computer, and the program is read and executed by a processor. Therefore, the present disclosure can also be realized as a program that can be executed by the processor or a non-transitory computer-readable medium that stores the program.

What is claimed is:

1. An information processing device comprising:
a communication unit; and
a control unit configured to perform communication using the communication unit, wherein the control unit is configured to present, on a display screen of a navigation device of a vehicle, a first route including a section where green wave travel is possible and created in response to a request from the navigation device, and present a predetermined travel speed on the display screen when the vehicle enters a start point of the section.

2. The information processing device according to claim 1, further comprising a storage unit, wherein the control unit is configured to store, in the storage unit, a power cost obtained by dividing an amount of electric power received from the vehicle and consumed during travel from the start point to an end point of the section by a distance of the section.

3. The information processing device according to claim 2, wherein the first route is a route in which a remaining charge level when the vehicle arrives at a destination of the vehicle is highest, the remaining charge level being created based on the power cost stored in the storage unit, a remaining charge level of a battery at a departure point of the vehicle, and distances of a plurality of routes connecting the departure point and the destination, including the section where the green wave travel is possible.

4. The information processing device according to claim 1, wherein the control unit is configured to further present, on the display screen, a second route that does not include the section where the green wave travel is possible, and present, for the first route and the second route presented on the display screen, expected times of arrival at a destination and estimated values of a remaining charge level of a battery at the expected times.

5. An information processing method comprising causing an information processing device to
create a first route including a section where green wave travel is possible in response to a request from a navigation device of a vehicle,
present the created first route on a display screen of the navigation device, and
present a predetermined travel speed on the display screen when the vehicle enters a start point of the section.
